(19) United States
(12) Patent Application Publication
(10) Pub. No.: US 2002/0100721 A1
(43) Pub. Date: Aug. 1, 2002

(54) Water purifying unit

(76) Inventors: Paul Stewart Huxtable, South Australia (AU); George Giles Campbell, South Australia (AU); Nicollette Lee Duance, South Australia (AU); Ian Geoffrey Hoskins, South Australia (AU); Steven May, South Australia (AU)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/017,507

(22) Filed: Dec. 13, 2001

(30) Foreign Application Priority Data
Dec. 13, 2000 (AU) PR2102

(51) Int. Cl. B01D 27/00; B01D 25/00

(52) U.S. Cl. 210/323.2

(57) ABSTRACT

A water purifying unit having a unique construction which enables it to be easily manufactured, assembled and serviced. The construction of the unit is such that it can with stand increased water pressure levels and is thus less prone to damage from water hammer.

### RELATED APPLICATION INFORMATION

This application claims priority under 35 U.S.C. §119(e) to Australian patent application number PR2102, filed Dec. 13, 2000.

### FIELD OF THE INVENTION

The present invention relates to a water purifying unit and more particularly to a water purifying unit that can be installed for domestic use.

### BACKGROUND OF THE INVENTION

Over recent years the demand for high quality drinking water has greatly increased. Consumers have become more health conscious and more particular about the quality of the water that they drink. Although the water available in most people's homes would meet all of the standard water safety requirements, the taste and appearance of the water may not meet the consumer's expectations.

Many consumers have therefore resorted to installing water purifying units to purify their drinking water.

There are a number of different units available in the market place and the quality of these units varies. Furthermore, the expected lifespan of these units and the quality of the water produced from the units also varies greatly.

The present invention seeks to provide an improved water purifying unit.

### SUMMARY OF THE INVENTION

According to a first aspect of the present invention there is provided a water purifying unit including a head having a first and a second chamber, an inlet port, an outlet port and a transfer port between the first and second chambers, each of the first and second chambers being arranged so that a sump can be removably secured thereto, a diverter mounted within each of said first and second chambers, said diverter dividing its respective chamber into an inlet zone and an outlet zone, each said diverter further being arranged so that a purifying cartridge can be attached thereto and located within the associated sump, and wherein the head is arranged so that water can enter the head, pass into the inlet zone of the first chamber, through the associated cartridge and into the outlet zone of the first chamber, through the transfer port located in the head, into the inlet zone of the second chamber, through the associated purifying cartridge into the outlet zone of the second chamber and out through the outlet port of the head.

The head is preferably molded as a single unit from a plastics material. The preferred material is an ABS plastics. ABS plastics are a group of plastic materials based on blended copolymers of styrene-acrylo-nitrile and butadiene-acrylonitrile and on graft interpolymers of styrene and acrylonitrile with polybutadiene. After molding of the head the inlet port, transfer port and outlet port are formed in the head preferably by a single post molding drilling operation.

Each diverter is preferably molded from a plastics material. The preferred material is preferably an ABS plastics. The diverter is preferably shaped so that it can be pressed into its respective chamber and adhered thereto using an appropriate adhesive.

The inner wall of each chamber and the associated diverter preferably include a complimentary indentation and protrusion. This complimentary indentation and protrusion serve to properly position the diverter within its respective chamber during assembly of the unit. The inner wall of each chamber and the associated diverter may include alternative means for aiding the proper positioning of the diverter in the associated chamber.

The inner wall of each chamber and its associated diverter are configured so that when they are assembled together they define there between the inlet zone and the outlet zone.

Each diverter is configured so that a water purifying cartridge can be attached thereto. Preferably, the diverter and cartridge have complimentary bayonet type fitting means to enable the cartridge to be secured to the diverter.

In a preferred form, the diverter includes a centrally located bayonet aperture and the cartridge includes a bayonet fitting at an upper end. The bayonet fitting of the cartridge being arranged to pass through the bayonet aperture whereafter the cartridge can be rotated to positively locate the bayonet fitting within the diverter.

A double O-ring seal is preferably provided between the diverter and the upper end of the cartridge to prevent water leakage there between.

Each sump is preferably molded from a plastics material. The preferred material is an ABS plastics.

Each sump is preferably arranged to be attached to the head by a threaded connection. The upper inner wall of the sump preferably includes a screw thread arranged to threadedly engage with a complimentary screw thread on a lower end portion of the chamber to which it is to be secured.

An O-ring seal is provided between the lower end of each chamber and the associated sump to prevent water leakage.

The sump is preferably configured so that a cartridge can be secured to the respective diverter and then the sump connected to the head about the cartridge. Sufficient clearance is provided between the inner wall of the sump and the outer surface of the cartridge to enable water to flow into the sump and through the cartridge.

The cartridge preferably includes an upper end cap, a lower end cap, a fluid pathway and a filter member.

The cartridge is preferably substantially cylindrical in shape.

The fluid pathway of the cartridge enables water that has passed through the filter member of the cartridge to pass into the outlet zone of the chamber. Spaced peripherally about the lower end cap of the cartridge are at least a pair of protrusions. The protrusions being arranged to prevent side to side movement of a lower end of the cartridge when high water pressure loads are applied to the cartridge. The protrusions are sized so that the cartridge can fit within the sump while still preventing excessive side-to-side movement of the cartridge under load conditions.

Preferably, the protrusions take the form of triangular shaped wings which extend outwardly of the cartridge.

In a preferred form, the head includes means for enabling the unit to be attached to a surface such as a sidewall of a cupboard.

A decorative cover may be arranged to fit on the head to provide an improved aesthetic appearance to the unit.

### BRIEF DESCRIPTION OF THE DRAWINGS

An embodiment of the invention will now be described, by way of example only, with reference to the accompanying drawings in which:

FIG. 1 is a perspective view of a purifying unit in accordance with an embodiment of the invention.

FIG. 2 is an assembly view of the purifying unit shown in FIG. 1.

FIG. 3 is a vertical cross-sectional view of the purifying unit shown in FIG. 1.

FIG. 4 is a rear view of the water purifying unit as shown in FIG. 1.

### DETAILED DESCRIPTION OF THE PREFERRED EMBODIMENT

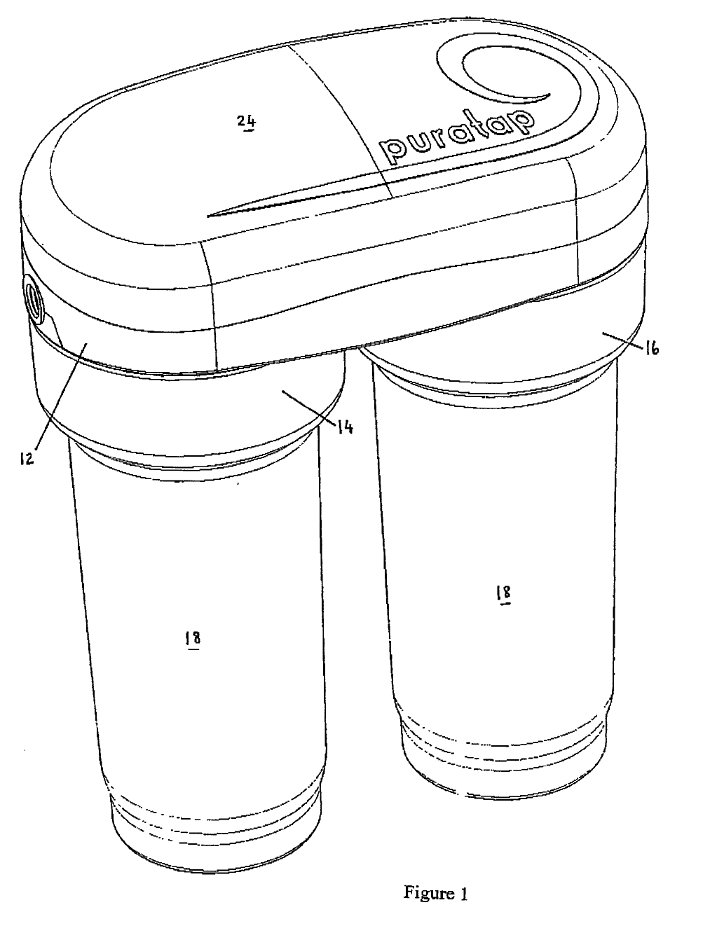

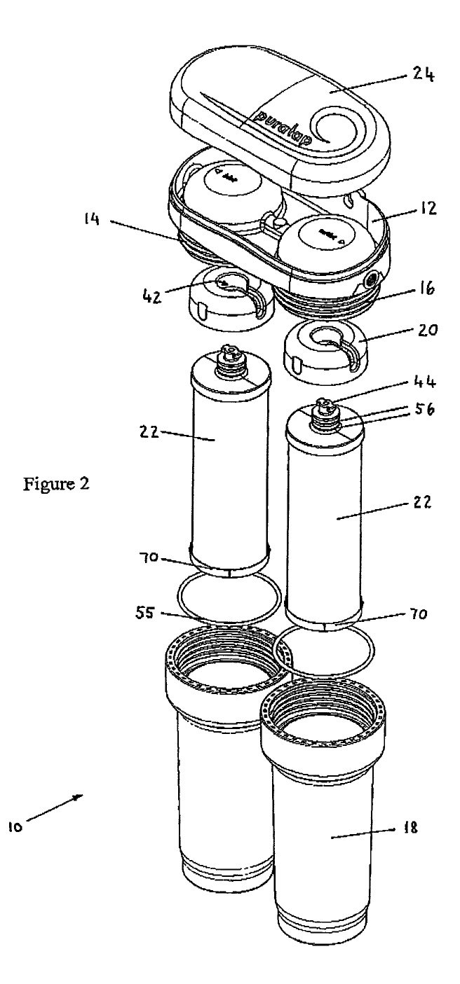

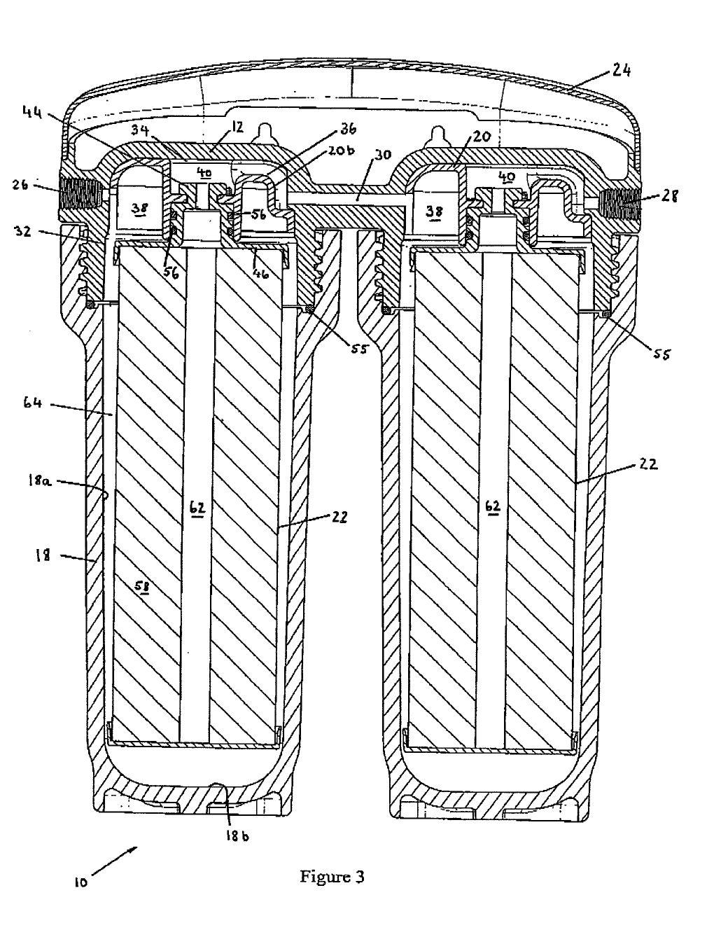

A water purifying unit 10 in accordance with an embodiment of the invention is shown in FIG. 1. The water purifying unit 10 includes a head 12 having first and second open ended chambers 14, 16 formed therein. A sump 18 is arranged to be removably secured to the lower end 14a, 16a of each of the first and second chambers 14, 16. Positioned within the respective chambers 14, 16 and sumps 18 are a diverter 20 and filter cartridge 22. As will be described in more detail below and as illustrated in FIGS. 2 and 3, a diverter 20 is arranged to be permanently mounted within the upper end of each of the first and second chambers 14, 16. A filter cartridge 22 is in turn arranged to be removably connected to an associated diverter 20. A decorative cover 24 is snap fitted to the upper side 12a of the head 12.

The components of the water purifying unit 10 are best illustrated in FIGS. 2 and 3. As shown in these figures, the head 12 includes an inlet port 26, an outlet 28 and a transfer port 30 which extends between the first and second chambers 14, 16. Each of the first and second chambers 14, 16 has a substantially cylindrical configuration and includes a chamber side wall 32 and a chamber top wall 34. The transition between the chamber side wall 32 and the chamber top wall 34 is smooth with a large radius of curvature.

Located within each of the first and second chambers 14, 16 is the diverter 20. The diverter 20 includes an upper wall portion 20a which is shaped so that it can be located with a press fit within its associated chamber 14, 16. The diverter 20 includes an indentation 20b which when located within its associated chamber 14, 16 is arranged to fit over a complimentary shaped protrusion 36 formed on the chamber top wall 34. The complimentary indentation 20b and protrusion 36 serve to properly position the diverter 20 within its respective chamber 14,16.

When the diverter 20 is properly located within its associated chamber 14, 16 it divides its associated chamber 14, 16 into an inlet zone 38 and an outlet zone 40.

The diverter 20 includes a centrally located bayonet aperture 42 which is arranged to receive a bayonet fitting 44 which is formed as part of an upper end cap 46 of the filter cartridge 22. The bayonet aperture 42 is arranged so that the bayonet fitting 44 can pass there through and subsequently be rotated so as to positively locate the bayonet fitting 44 of the filter cartridge 22 within the diverter 20.

Once a filter cartridge 22 has been connected to the diverter 20, a sump 18 is connected to the associated chamber 14, 16. The sump 18 is connected to the associated chamber 14, 16 by means of a threaded connection. As is best illustrated in FIG. 3, an upper inner side wall 18a of the sump 18 includes a threaded portion 18b which is arranged to engage with a threaded portion formed on the periphery of the lower portion of the side wall 52. The sump 18 is configured so that the transition between the inner side wall 18a of the sump 18 and the inner bottom wall 18b is smooth with a large radius of curvature.

To ensure water tightness of the purifying unit 10 an O-ring seal 55 is located between the lower edge of the side wall 52 of each of the chambers 14, 16 and the associated sump 18. In addition, a double O-ring seal 56 is provided between the diverter 20 and the bayonet fitting 44 of the filter cartridge 22. As best illustrated in FIG. 3, the filter cartridge 22 includes a filter element 58 which is located between the upper end cap 46 and a lower end cap 60. A fluid pathway 62 is located substantially centrally of the filter element 58 so that water passing through the filter element 58 can enter the fluid pathway 62 and be driven upwardly in a manner described in more detail subsequently.

The cartridge 22 is sized so that when it is connected to the diverter 20 and the associated sump 18 is attached to the head 12, there is a clearance space 64 between the inner side wall 18a of the sump 18 and the outer periphery of the filter cartridge 22.

In use, the filter unit 10 is connected to a water supply so that water can flow through the unit 10 and be purified. Water passes through the inlet port 26 and into the inlet zone 30 of the first chamber 14. The water then flows through the clearance space 64. Once the sump 18 is full, the water is caused to flow through the filter element 58 and into the fluid pathway 62. The water then passes up the fluid pathway 62 through the upper end of the bayonet fitting 44 and into the outlet zone 34 of the first chamber 14. The water then passes through the transfer port 30 which connects the first and second chambers 14, 16. The previously described cycle is then repeated within the second chamber 16. That is, the water passes into the inlet zone 38 of the second chamber, into the clearance space 64, through the filter element 58, up the fluid path 62 and into the outlet zone 40 of the second chamber 16. The purified water then passes through the outlet port 28 of the purifying unit 10 whereafter it passes into pipework connected to a conventional plumbing outlet.

As best illustrated in FIG. 2, located peripherally about the lower end cap 60 are a series of protrusions 70. The protrusions 70 take the form of triangular shaped wings which extend outwardly of the filter cartridge 22. The purpose of the protrusions 70 is to prevent excessive side to side movement of the filter cartridge 22 under high water load conditions. Without the protrusions 70 the filter cartridge 22 under high load conditions may be jarred back and forth in a side to side motion. As the filter cartridge 22 is only held in position by the location of the bayonet fitting 44 within the bayonet aperture 42, side to side movement of the cartridge 22 may result in the bayonet fitting 44 becoming damaged and may in fact cause the bayonet fitting 44 to snap off so that the cartridge 22 is disconnected. The inclusion of the protrusions 70 substantially reduces if not totally prevents side to side movement of the filter cartridge 22 which may result from high water load forces. Such forces often occur if there is water hammer within the pipe work to which the purifying unit 10 is connected.

The head 12 is molded as a single unit from a plastics material. The preferred material is an ABS plastics. After molding of the head 12 the inlet port 26, transfer port 30 and outlet port 38 are formed by a single post molding drilling operation. Basically, a drill of appropriate size is bored through the head 12 to form the inlet, transfer and outlet ports 26, 30, 28. The inlet and outlet ports 26, 28 are then threaded so that they can be readily connected to the water pipework of the home etc.

After the ports 26, 30, 28 are formed in the head 12, a diverter 20 is located within each of the first and second chambers 14, 16. The diverter 20 is molded from a plastics material and is preferably made from an ABS plastics. The configuration of the diverter 20 and the inner walls 32, 34 of the chambers 14, 16 is such as to enable the diverter 20 to be located within the associated chamber 14, 16 with a press fit. An appropriate adhesive is used to permanently locate the diverter 20 within the associated chamber 14, 16.

Each sump 18 is molded from a plastics material. The preferred material for each of the sumps 18 is an ABS plastics. The materials from which the head 12, sump 18 and diverter 20 are made have been selected so as to ensure adequate strength of these components and to reduce the creep of these components. In this way, any variation in the structure of the various components due to creep is minimised and therefore the ultimate fit between the components will be maintained after many hours of continuous use.

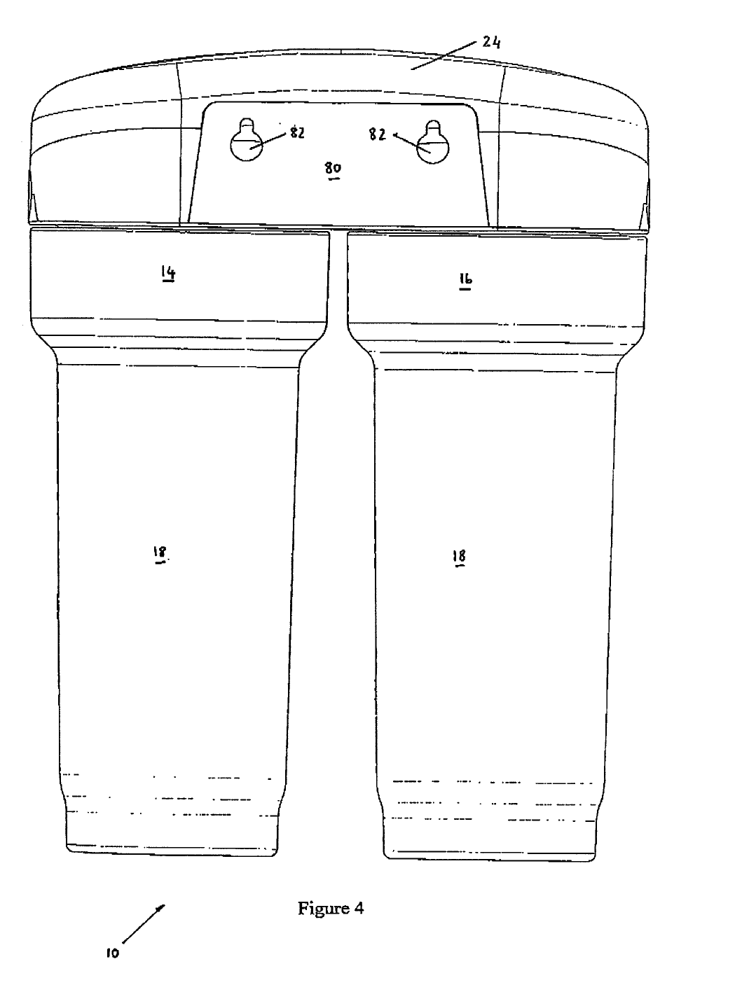

As shown in FIG. 4, the head 12 also includes an attachment surface 80 which includes a pair of apertures 82. These apertures 82 are arranged to fit over a protruding screw which is connected to a wall, such as a sidewall to a cupboard. In this manner, the purifying unit 10 can be mounted against the side wall of a cupboard or other wall.

As stated previously, a decorative cover 24 is located on the upper side 12a of the head 12. The cover 24 is provided to improve the aesthetic appearance of the purifying unit 10.

A purifying unit 10 in accordance with an embodiment of the invention has many advantages over prior art devices. For example, in previous devices the head and chambers were made from a number of different components which were assembled together in a cumbersome and time consuming manner. In addition, the two chambers had to be connected by a connection in the form of a nipple which was manually positioned and attached between the two sumps.

It will also be appreciated by those skilled in the art that in prior art devices the filter cartridge was positioned within the sump between upper and lower seats. When the sump was tightened to the head the seal between the upper and lower seats and the ends of the cartridge was perfected. However, over time and with creep of the various components of such prior art units, the integrity of the seal was lost and thus the effectiveness of the purifying unit decreased. The configuration of the purifying unit in accordance with an embodiment of the invention eliminates this problem because of the use of the bayonet type fitting to secure the filter cartridge to the head. Thus, any creep within the system will not affect the effectiveness of the filtering system.

It will also be appreciated that the large smooth curves formed between the side and bottom wall of the sump 18, together with the materials from which the various components of the purifying unit 10 are made, result in a purifying unit 10 that can be used under increased water pressure levels. For example, conventional water purifying units are normally considered to be able to safely operate with static water pressure levels of 500 psi. However, it is envisaged that a purifying unit 10 in accordance with an embodiment of this invention will be able to withstand static water pressure levels up to 750 psi. It is also envisaged that a water purifying unit 1 in accordance with an embodiment of the invention will be able to withstand water hammer pressures between 1500 and 1600 psi.

A water purifying unit 10 made in accordance with an embodiment of the invention will be easier to manufacture because of the reduced number of components, will be able to withstand higher static water pressure levels and will maintain its water purifying capabilities despite any creep in the component parts thereof. All of these advantages are achieved while still maintaining a construction which can be easily disassembled to enable changeover of the filter cartridges 22. Furthermore, the filter cartridges 22 can be easily connected to the associated diverter 20 simply by passing the bayonet fitting 44 through the bayonet aperture 42 and rotating the cartridge 22. The positive connection between the filter cartridge 22 and the bayonet aperture 42 means that the user can readily identify when the filters cartridge 22 is properly located.

The embodiment has been described by way of example only and modifications within the spirit and scope of the invention are envisaged.

The claims defining the invention are as follows

1. A water purifying unit including a head having a first and a second chamber, an inlet port, an outlet port and a transfer port between the first and second chambers, each of the first and second chambers being arranged so that a sump can be removably secured thereto, a diverter mounted within each of the first and second chambers, the diverter dividing its respective chamber into an inlet zone and an outlet zone, each diverter further being arranged so that a purifying cartridge can be attached thereto and located within the associated sump, and wherein the head is arranged so that water can enter the head, pass into the inlet zone of the first chamber, through the associated cartridge and into the outlet zone of the first chamber, through the transfer port located in the head, into the inlet zone of the second chamber, through the associated purifying cartridge into the outlet zone of the second chamber and out through the outlet port of the head.

2. A water purifying unit according to claim 1 wherein the head is molded as a single unit from a plastics material.

3. A water purifying unit according to claim 2 wherein the plastics material is an ABS plastics.

4. A water purifying unit according to claim 2 wherein the transfer port and outlet port are formed in the head by a single post molding drilling operation.

5. A water purifying unit according to claim 2 wherein each diverter is molded from a plastics material.

6. A water purifying unit according to claim 5 wherein the plastics material is an ABS plastics.

7. A water purifying unit according to claim 1 wherein the diverter is shaped so that it can be pressed into its respective chamber and adhered thereto using an appropriate adhesive.

8. A water purifying unit according to claim 1 wherein the inner wall of each chamber and the associated diverter include means for the proper positioning of the diverter in the associated chamber during assembly of the unit.

9. A water purifying unit according to claim 8 wherein the positioning means includes a complimentary indentation and protrusion.

10. A water purifying unit according to claim 1 wherein the inner wall of each chamber and its associated diverter are configured so that when they are assembled together they define there between the inlet zone and the outlet zone.

11. A water purifying unit according to claim 1 wherein the diverter and cartridge have complimentary bayonet type fitting means to enable the cartridge to be secured to the diverter.

12. A water purifying unit according to claim 11 wherein the diverter includes a centrally located bayonet aperture and the cartridge includes a bayonet fitting at an upper end thereof.

13. A water purifying unit according to claim 12 wherein the bayonet fitting of the cartridge is arranged to pass through the bayonet aperture whereafter the cartridge can be rotated to positively locate the bayonet fitting within the diverter.

14. A water purifying unit according to claim 1 wherein a seal is provided between the diverter and the upper end of the cartridge to prevent water leakage there between.

15. A water purifying unit according to claim 1 wherein each sump is molded from a plastics material.

16. A water purifying unit according to claim 15 wherein the plastics material is an ABS plastics.

17. A water purifying unit according to claim 1 wherein each sump is arranged to be attached to the head by a threaded connection.

18. A water purifying unit according to claim 17 wherein the upper inner wall of the sump includes a screw thread arranged to threadedly engage with a complimentary screw thread on a lower end portion of the chamber to which it is to be secured.

19. A water purifying unit according to claim 18 wherein a seal is provided between the lower end of each chamber and the associated sump to prevent water leakage.

20. A water purifying unit according to claim 1 wherein the sump is configured so that a cartridge can be secured to the respective diverter and then the sump connected to the head about the cartridge.

21. A water purifying unit according to claim 1 wherein sufficient clearance is provided between the inner wall of the sump and the outer surface of the cartridge to enable water to flow into the sump and through the cartridge.

22. A water purifying unit according to claim 1 wherein the cartridge includes an upper end cap, a lower end cap, a fluid pathway and a filter member and wherein the fluid pathway of the cartridge enables water that has passed through the filter member of the cartridge to pass into the outlet zone of the chamber.

23. A water purifying unit according to claim 22 wherein spaced peripherally about the lower end cap of the cartridge are at least a pair of protrusions which are arranged to restrict or prevent side to side movement of a lower end of the cartridge when high water pressure loads are applied to the cartridge.

24. A water purifying unit according to claim 23 wherein the protrusions take the form of triangular shaped wings which extend outwardly of the cartridge.

25. A water purifying unit according to claim 1 further including means for enabling the unit to be attached to a surface such as a sidewall of a cupboard.

26. A water purifying unit according to claim 1 further including a decorative cover arranged to fit on the head to provide an improved aesthetic appearance to the unit.
